(19) United States
(12) Patent Application Publication
(10) Pub. No.: US 2025/0205675 A1
(43) Pub. Date: Jun. 26, 2025

(54) REMOVAL AGENT FOR FINE-REMOVAL OF CO IN HYDROGEN, AND PREPARATION METHOD THEREFOR AND USE THEREOF

(71) Applicants: CHINA ENERGY INVESTMENT CORPORATION LIMITED, Beijing (CN); NATIONAL INSTITUTE OF CLEAN-AND-LOW-CARBON ENERGY, Beijing (CN)

(72) Inventors: Xiuying GUO, Beijing (CN); Guangli HE, Beijing (CN); Congmin LIU, Beijing (CN)

(21) Appl. No.: 18/849,447

(22) PCT Filed: Oct. 19, 2022
(86) PCT No.: PCT/CN2022/126098

§ 371 Date: Sep. 20, 2024

(30) Foreign Application Priority Data
Mar. 29, 2022 (CN) 202210319309.1

(51) Int. Cl. B01J 20/10; B01D 53/02; B01D 53/62; B01J 20/30

(52) U.S. Cl. CPC B01J 20/103; B01D 53/02; B01D 53/62; B01J 20/3071; B01J 20/3078; B01D 2253/104; B01D 2253/106; B01D 2256/16; B01D 2257/502

(57) ABSTRACT

The present disclosure provides a removal agent for fine-removal of CO in hydrogen, and a preparation method therefor and a use thereof. The removal agent provided in the present disclosure can thoroughly remove CO in hydrogen at a relatively low temperature such as room temperature to meet the harsh requirement of a fuel cell for the content of CO in hydrogen. According to the removal agent for fine-removal of CO in hydrogen provided in the disclosure, an active component of the removal agent comprise a composite metal oxide, metal elements in the composite metal oxide are Cu, Ce, Mn and Bi, a general formula of the composite metal oxide is CuₓCe_{3-x-y-z}Mn_{y}Bi_{z}O_{4+δ}, wherein a subscript value of each metal element is a number of atoms of the corresponding metal element in the composite metal oxide, “4+δ” is a number of oxygen atoms required to meet an oxidation state of other elements, 0.2<x<2, 0.05<y<2.8, 0.05<z<1, and x+y+z<3.

### CROSS-REFERENCE TO RELATED APPLICATIONS

This application is a U.S. National Stage of International Patent Application No. PCT/2022/126098 filed Oct. 19, 2022, which claims priority to Chinese Patent Application No. 202210319309.1 filed Mar. 29, 2022, both of which are incorporated by reference herein as if reproduced in their entireties.

### TECHNICAL FIELD

The present invention relates to the technical field of removing CO in hydrogen, and particularly to a removal agent for fine-removal of CO in hydrogen, and a preparation method therefor, and a use thereof.

### BACKGROUND

Proton exchange membrane fuel cells are very sensitive to impurities in hydrogen, so the purity of hydrogen used in hydrogen fuel cells should meet the requirements of ISO14687-2 standard and SAE J2719 Hydrogen Quality Standard for Fuel Cell Vehicles. The requirement of a national standard for pure hydrogen is that CO in produced hydrogen is less than 5 ppm, and the requirement for high-purity hydrogen is that CO in produced hydrogen is less than 1 ppm, while in fuel cells, CO is specified to be less than 0.2 ppm.

The CO impurity contents of industrial purity hydrogen and high-purity hydrogen can not meet the quality requirements of hydrogen used in the fuel cells, so that deep CO removal is needed. At present, PSA and TSA methods are used for removing/separating CO in hydrogen. These methods are generally used for separating high-concentration CO, removal agents used therein need to be reduced in situ before use, and there is a risk of introducing Cl ions. H₂O and CO₂ will affect the adsorption performance of these methods, and their application in hydrogen purification for the fuel cell vehicles is still controversial. In the traditional PSA purification process, it is difficult to remove a CO content to 0.2 ppm. In addition, a traditional catalytic oxidant can only oxidize CO at nearly 100° C. in the presence of O₂, and the introduction of O₂ into hydrogen has the risk of explosion and is prone to side reactions with hydrogen.

CN109499261A discloses a system and a method for removing CO in hydrogen for proton exchange membrane fuel cells. The removal system comprises a hydrogen storage tank, a CO adsorption purifier, a hydrogen heat exchanger and a fuel cell anode, which are communicated in sequence. This document provides a method for removing CO by using a removal system, which uses CuCl as a CO adsorbent. However, hydrogen for fuel cell vehicles has strict requirements for Cl ions (<0.05 ppm), so that the adsorbent has the risk of introducing Cl ions.

CN201210402065.X discloses a catalyst for oxidation removal of carbon monoxide in hydrogen and a preparation method therefor. This document provides a catalyst for selective oxidation removal of carbon monoxide in high-concentration hydrogen, and a preparation method therefor and a use method thereof. The catalyst is a carrier loaded with an active component and an additive; the active component is Pt, and the additive is one or a combination of two of Zn, Cu, La, Ce, Pr, Fe, Sn and Co; a loading capacity of the active component is 0.01-0.1% (wt%) of the catalyst, and the loading capacity of the additive is 0.5-5% (wt%) of the catalyst. This document provides a noble metal catalyst, which can remove carbon monoxide in hydrogen at 100° C.-200° C. On one hand, the energy consumption is high at a high temperature, on the other hand, it will lead to a competitive reaction between hydrogen and CO, and produce by-product of H₂O.

### SUMMARY

In view of this, the present disclosure provides a removal agent for fine-removal of CO in hydrogen, a preparation method therefor and a use thereof. The removal agent provided by the present disclosure can remove CO in hydrogen at a relatively low temperature, such as room temperature, so as to meet the harsh requirements of fuel cells for a CO content in hydrogen.

In order to achieve the purpose of the present disclosure, the present disclosure provides the following technical solutions.

The present disclosure provides a removal agent for fine-removal of CO in hydrogen, an active component of the removal agent comprises a composite metal oxide, metal elements in the composite metal oxide are Cu, Ce, Mn and Bi, a general formula of the composite metal oxide is CuₓCe_{3-x-y-z}Mn_{y}Bi_{z}O_{4+δ}, wherein a subscript value of each metal element is a number of atoms of the corresponding metal element in the composite metal oxide, “4+δ” is a number of oxygen atoms required to meet an oxidation state of other elements, 0.2<x<2, 0.05<y<2.8, 0.05<z<1, and x+y+z<3.

In some embodiments, the active component of the removal agent further optionally comprises other active constituent(s), said other active constituent(s) are selected from one or more of an oxide of Ca, an oxide of K and an oxide of La, a content of said other active constituent(s) is 0.2-20 wt % based on the weight of the composite metal oxide.

In some embodiments, the removal agent further comprises other component(s), said other component(s) comprise an oxide of silicon and/or an oxide of aluminum.

In some embodiments, a percentage by weight of said other component(s) based on the removal agent is 2-30%.

Preferably, in the general formula of the composite metal oxide, 1<x<2.

Preferably, in the general formula of the composite metal oxide, 0.05<z<0.5.

Preferably, in the general formula of the composite metal oxide, 0.5<y≤2, preferably 0.5<y≤1.5.

Preferably, in the general formula of the composite metal oxide, 2.1≤x+y+z≤2.97.

Preferably, in the general formula of the composite metal oxide, 0.5<y≤2, and 2.1≤x+y+z≤2.97.

The present disclosure further provides a preparation method for the removal agent, comprising the following steps of:
1) mixing soluble salts of the metal elements corresponding to the oxides in the active component and preparing an aqueous solution, adding an alkaline substance into the aqueous solution, adjusting the pH to 6-9 to generate coprecipitation, aging, filtering out and washing the coprecipitate to obtain a filter cake;
2) optionally, uniformly mixing the filter cake with optional other component(s) and moulding the mixture; said other component(s) comprising carriers and/or binders, said carriers and/or binders containing a silicon element and/or an aluminum element; preferably, said other component(s) being selected from one or more of silica sol, potassium silicate, alumina sol and pseudo-boehmite;
3) calcinating to obtain the removal agent.

In some embodiments, conditions for the calcination comprise a calcination temperature of 200-600° C., a calcination time of 2-12 hours.

The present disclosure further provides a method for removing CO in hydrogen, the CO in hydrogen is removed by using the removal agent described above. CO can be removed at the low temperature by the removal agent in the present disclosure. In some embodiments, the CO in hydrogen is removed at a temperature of 100° C. or below, preferably at a room temperature. Furthermore, the removing is carried out in the presence or absence of oxygen.

The technical solutions provided by the present disclosure have the following beneficial effects.

The removal agent provided by the present disclosure can remove the CO in hydrogen at the room temperature, so that the CO can be converted into CO₂ which is easy to be removed and has weak toxicity to the fuel cells, and the purpose of removal can be achieved without (or extremely low) consuming hydrogen in the process of removing the CO. A removal process based on the removal agent according to the disclosure is simple and easy, and has a low operation cost; and CO conversion can be realized without oxygen, which avoids an explosion risk caused by introducing oxygen into hydrogen. The removal agent of the present disclosure has an excellent effect on removing the CO in hydrogen, and can remove the CO to 0 ppm, and the removal agent of the present disclosure can adapt to the removal of CO at different concentration levels.

### DETAILED DESCRIPTION

In order to facilitate the understanding of the present disclosure, the present disclosure will be further described in conjunction with examples. It should be understood that the following examples are only for better understanding of the present disclosure, and do not mean that the present disclosure is limited to the following examples.

Unless otherwise defined, all technical and scientific terms used herein shall have the same meaning as commonly understood by those skilled in the technical field to which the present disclosure belongs. The term “and/or” that may be used herein includes any and all combinations of one or more related listed items.

Endpoints of ranges and any values disclosed herein are not limited to the precise ranges or values, and these ranges or values should be understood to contain values close to these ranges or values. For numerical ranges, one or more new numerical ranges can be obtained by combining the endpoint values of various ranges, combining endpoint values of various ranges and individual point values, and combining individual point values, and these numerical ranges should be regarded as specifically disclosed herein.

Where the specific experimental steps or conditions are not specified in the examples, the operation or conditions of the corresponding conventional experimental steps in the technical field can be followed. If manufacturers are not indicated in reagents or instruments used, the reagents or instruments are all conventional products that can be obtained through market purchase.

The present disclosure provides a removal agent for fine-removal of CO in hydrogen, an active component of the removal agent mainly comprises the following composite metal oxide, metal elements in the composite metal oxide are Cu, Ce, Mn and Bi, that is, the composite metal oxide is composed of an oxide of Cu, an oxide of Ce, an oxide of Mn and an oxide of Bi. In some embodiments, the active component may only comprise the above-mentioned composite metal oxide. In the removal agent provided by the present disclosure, a general formula of the composite metal oxide is CuₓCe_{3-x-y-z}Mn_{y}Bi_{z}O_{4+δ}. wherein a subscript value of each metal element, such as x, 3−x−y−z, y and z, is a number of atoms of the corresponding metal element in the composite metal oxide, “4+δ” is a number of oxygen atoms required to meet an oxidation state of other elements, 0.2<x<2, 0.05<y<2.8, 0.05<z<1, and x+y+z<3.

The removal agent provided by the present disclosure mainly takes the combination of oxides of Cu, Ce, Mn and Bi as the active component, and through the composite metal oxide based on these four metal elements, lattice defects are easily formed at an interface, which is beneficial to transfer electrons, form more oxygen vacancies, enhance the ability to release or capture oxygen molecules, increase the CO removal activity and facilitate the reduction of CO at a low temperature.

According to the removal agent of the present disclosure, in the general formula of the composite metal oxide, 0.2<x<2, 0.05<y<2.8, 0.05<z<1, and x+y+z<3. CO in hydrogen can be removed more thoroughly by the removal agent based on the composite metal oxide at a relatively low temperature, such as the room temperature. In some preferred embodiments, in the general formula of the composite metal oxide, 1<x<2, which is beneficial to prolong a usable time of the removal agent for CO removal. In some preferred embodiments, 0.05<z<0.5, which can improve the usable time of the removal agent for CO removal. In some preferred embodiments, 0.5<y≤2, preferably 0.5<y≤1.5, which is beneficial to prolong the usable time of the removal agent for CO removal. In some preferred embodiments, 2.1≤x+y+z≤2.97, the removal agent can obtain a longer usable time for CO removal. In some preferred embodiments, 0.5<y≤2, and 2.1≤x+y+z≤2.97, the removal agent can obtain a longer usable time for CO removal.

In some embodiments, in addition to the above-mentioned composite metal oxide, the active component of the removal agent of the present disclosure can optionally comprise other active constituent(s), said other active constituent(s) are selected from one or more of an oxide of Ca, an oxide of K and an oxide of La, a content of said other active component(s) is 0.2-20 wt % based on the weight of the composite metal oxide (that is, the composite metal oxide of Cu, Ce, Mn and Bi). The introduction of the additional active constituent(s) is beneficial to enhance the adsorption of CO, promote the conversion of CO into CO₂, and inhibit the generation of H₂O.

The removal agent of the present disclosure may contain only the above active component, or may be obtained by compounding the above active component with other component(s), such as an oxide of silicon and/or an oxide of aluminum, specifically, SiO₂ and/or Al₂O₃. In some embodiments, a percentage by weight of said other component(s) based on the removal agent of the present disclosure is 2-30%, and the rest refers to the active component and optionally existing other active constituent(s). SiO₂ and/or Al₂O₃ can be derived from carriers and/or binders containing a silicon element and/or an aluminum element, for example, from one or more of silica sol, potassium silicate, alumina sol and pseudo-boehmite. These carriers and/or binders can directly adopt corresponding raw materials on the market, and the introduction of SiO₂ and/or Al₂O₃ can increase the dispersion of active phase of the removal agent and the strength of moulded particles.

The present disclosure also provides a preparation method for the above removal agent, which specifically comprises the following steps of:
1) mixing soluble salts of the metal elements corresponding to the oxides in the active component and preparing an aqueous solution, adding an alkaline substance into the aqueous solution, adjusting the pH to 6-9 to generate coprecipitation, aging (for example, aging for 10-300 minutes), filtering out and washing the coprecipitate to obtain a filter cake;
2) optionally, uniformly mixing the filter cake with optional other component(s) and moulding the mixture; said other component(s) comprising carriers and/or binders, said carriers and/or binders containing a silicon element and/or an aluminum element, for example, one or more of silica sol, potassium silicate, alumina sol and pseudo-boehmite; and thereby introducing the corresponding oxide of silicon and/or oxide of aluminum into the removal agent;
3) calcinating to obtain the removal agent.

In the step 1), “the soluble salts of the metal elements corresponding to the oxides in the active component” specifically refer to the soluble salts of Cu, Ce, Mn and Bi elements, and the soluble salts of Ca, K and La elements that may be contained; the soluble salts can be, but are not limited to, nitrates, sulfates, acetates, oxalates and hydrates thereof, for example, copper nitrate trihydrate, cerium nitrate hexahydrate, manganese nitrate hexahydrate, bismuth nitrate pentahydrate and the like. In some embodiments, in the step 1), a molar concentration of an aqueous solution prepared by mixing the soluble salts is 0.05-2 mol/L.

In the step 1), the alkaline substance used to adjust the pH to 6-9 is not particularly limited, and can be, for example, a sodium hydroxide aqueous solution, a sodium carbonate aqueous solution or an ammonia aqueous solution, and the alkaline substance used can be, for example, an aqueous solution with a concentration of 0.05-2 mol/L. In some embodiments, in the step 1), deionized water is specifically used for washing, mainly to remove sodium ions and the like.

In some embodiments, in the step 3), conditions for the calcination specifically comprise a calcination temperature of 200-600° C., a calcination time of 2-12 hours.

The present disclosure further provides a method for removing CO in hydrogen, the CO in hydrogen is removed by using the removal agent described above. The CO in hydrogen can be removed at a temperature of 100°° C. or below by the removal agent of the present disclosure, specifically, the CO can be removed, for example, at a room temperature. Effective removal can be achieved without the need for additional heat treatment. The removal agent of the present disclosure can remove the CO in hydrogen in the presence of absence of oxygen, and preferably, the removal agent can remove the CO in hydrogen in the absence of oxygen. When using a condition where oxygen is present, a problem that oxygen can not be completely converted occurs, and oxygen impurities are additionally introduced.

The present disclosure will be exemplified by specific examples.

### Example 1

Calculated amounts of copper nitrate trihydrate, cerium nitrate hexahydrate, manganese nitrate hexahydrate and bismuth nitrate pentahydrate were weighed respectively, and dissolved with deionized water to obtain a nitrate solution A with a concentration of 0.2 mol/L (which was calculated by a molar sum of Cu, Mn, Ce and Bi ions); then a NaOH aqueous solution with a concentration of 0.2 mol/L was prepared; under a stirring state, the NaOH aqueous solution was added into the nitrate solution A to adjust the pH value to 7.5 to generate coprecipitate; the coprecipitate was aged for 60 minutes, the coprecipitate was then filtered out and washed until sodium ions were removed to obtain a filter cake; and the filter cake was calcinated at 400° C. for 10 hours to obtain a removal agent which was a mixture of oxides of Cu, Ce, Mn and Bi (that was, a composite metal oxide). The removal agent could be expressed as CuCe_{0.4}Mn_{1.5}Bi_{0.1}O_{4+δ} according to an atomic number ratio of each element, wherein 4+δ is a number of oxygen atoms required to meet an oxidation state of other elements in the general formula (the same applies to the values of 4+δ in subsequent examples, and will not be further elaborated).

### Examples 2-6

Removal agents of Examples 2-6 were prepared according to the preparation method of Example 1, and the only difference from Example 1 was to adjust the usage amounts of copper nitrate trihydrate, cerium nitrate hexahydrate, manganese nitrate hexahydrate and bismuth nitrate pentahydrate, so as to finally obtain the removal agents with a general formula of CuₓCe_{3-x-y-z}Mn_{y}Bi_{z}O_{4+δ}and values of x, y and z were the corresponding values in Table 1.

### Example 7

Calculated amounts of copper nitrate trihydrate, cerium nitrate hexahydrate, manganese nitrate hexahydrate and bismuth nitrate pentahydrate were weighed respectively, and dissolved with deionized water to obtain a nitrate solution A with a concentration of 0.2 mol/L (which was calculated by a molar sum of Cu, Mn, Ce and Bi ions); then a NaOH aqueous solution with a concentration of 0.2 mol/L was prepared; under a stirring state, the NaOH aqueous solution was added into the nitrate solution A to adjust the pH value to 7.5 to generate coprecipitate; the coprecipitate was aged for 60 minutes, the coprecipitate was then filtered out and washed until sodium ions were removed to obtain a filter cake; 8% pseudo-boehmite was added into the filter cake according to a dry basis mass, kneaded evenly, extruded and moulded, and calcinated at 400° C. for 10 hours to obtain the removal agent, which was expressed as 92% CuCe_{0.4}Mn_{1.5}Bi_{0.1}O_{4+δ}+8% Al₂O₃; the removal agent was composed of aluminum oxide and an active component, wherein the aluminum oxide accounted for 8 wt % and the active component accounted for 92 wt %. The active component was a mixture of oxides of Cu, Ce, Mn and Bi (that was, a composite metal oxide), and each element in the active component was expressed as CuCe_{0.4}Mn_{1.5}Bi_{0.1}O_{4+δ} according to an atomic number ratio.

### Example 8

A preparation process of a removal agent was basically the same as that of Example 7, and the only difference was that the pseudo-boehmite was replaced by silica sol. The obtained removal agent was expressed as 92% CuCe_{0.4}Mn_{1.5}Bi_{0.1}O_{4+δ}+8% SiO₂, which was composed of silicon dioxide and an active component, wherein the silicon dioxide accounted for 8 wt % and the active component accounted for 92 wt %, and the active component was a mixture of oxides of Cu, Ce, Mn and Bi (that was, a composite metal oxide), and each element in the active component was expressed as CuCe_{0.4}Mn_{1.5}Bi_{0.1}O_{4+δ} according to an atomic number ratio.

### Example 9

A preparation process of a removal agent was basically the same as that of Example 7, the only difference was that potassium nitrate was added to the nitrate solution A. The obtained removal agent was expressed as 91% CuCe_{0.4}Mn_{1.5}Bi_{0.1}O_{4+δ}+8% Al₂O_{3 +}K₂O 1%, which was composed of aluminum oxide and an active component, wherein the aluminum oxide accounted for 8 wt %, and the active component comprised a composite metal oxide of Cu, Ce, Mn and Bi as well as an oxide of K, wherein the composite metal oxide of Cu, Ce, Mn and Bi accounted for 91 wt % and the oxide of K accounted for 1 wt %.

### Performance Investigation

At a room temperature (25°° C.) and an atmospheric pressure, with 0.5% (v/v) CO+H₂ as a feed gas, the removal agent of each example was directly filled into a reaction tube without pretreatment, and removal effects of the removal agents with different compositions on CO in the feed gas were tested under an oxygen-free condition. Results were shown in the following Table 1 and Table 2.

Wherein “CO penetration time” means that a CO content at an outlet end of the reaction tube is monitored, a timer starts when the feed gas is introduced into the reaction tube, and the timer stops when CO is monitored at the outlet end of the reaction tube, a time span therebetween is referred to as the CO penetration time. The CO content was detected by an Agilent portable chromatography Micro-GC.

In Table 2, “strength” is a value obtained by dividing a crushing resistance force of the removal agent (obtained by using an automatic digital particle strength meter) by a length of the removal agent to be detected.

TABLE 1
Relationship between Sample Composition
and CO Removal Performance

| | | | | CO Penetration |
|---|---|---|---|---|
| Serial No. | x | y | z | Time (min) |
| Example 1 | 1 | 1.5 | 0.1 | 83 |
| Example 2 | 1 | 1 | 0.3 | 78 |
| Example 3 | 1.5 | 1.0 | 0.3 | 102 |
| Example 4 | 1.5 | 0.5 | 0.1 | 67 |
| Example 5 | 1.5 | 1.0 | 0.5 | 62 |
| Example 6 | 1 | 1 | 0 | 65 |

In Table 1, x, y and z correspond to x, y and z in the general formula CuₓCe_{3-x-y-z}Mn_{y}Bi_{z}O_{4+δ} of the removal agent.

It can be seen from Table 1 that the effect of Example 3 is the best and the removal agent can be used for the longest time. By comparing Example 2 with Example 3, it can be seen that when the values of y and z are the same, the larger x is, the longer the penetration time of the removal agent is; an optimum range of x is 1<x<2. z represents Bi element (with a larger molecular weight), to ensure the activity of the removal agent per unit mass, the content of this element should not be too high, preferably 0.05<z<0.5.

By comparing Example 3 with Example 4, it can be seen that when the value of x is the same, the penetration time of the removal agent is obviously shortened when the value of y is reduced, indicating that the value of y cannot be too low. Preferably, the preferred value range of y is 0.5<y≤1.5.

By comparing Example 3 with Example 5, it can be seen that when x+y+z=3, the adsorbent is active without Ce, but the penetration time is reduced from 102 minutes to 62 minutes; By comparing Example 2 with Example 6, it can be seen that when z=0, the adsorbent is active without Bi, but the penetration time is reduced from 78 minutes (when the Bi content is 0.3) to 65 minutes. It shows that several metals have synergistic effect, and the effect is not good without one of the metals.

TABLE 2
Strength Improvement by Binders

| | | CO | |
|---|---|---|---|
| Serial | | Penetration | Strength |
| No. | Composition | Time (min) | (N/cm) |
| Example 1 | CuCe_{0.4}Mn_{1.5}Bi_{0.1}O_{4+δ} | 83 | 30 |
| Example 7 | 92% CuCe_{0.4}Mn_{1.5}Bi_{0.1}O_{4+δ} + 8% | 78 | 59 |
| | Al₂O₃ | | |
| Example 8 | 92% CuCe_{0.4}Mn_{1.5}Bi_{0.1}O_{4+δ} + 8% | 86 | 41 |
| | SiO₂ | | |
| Example 9 | 91% CuCe_{0.4}Mn_{1.5}Bi_{0.1}O_{4+δ} + 8% | 82 | 58 |
| | Al₂O₃ + K₂O 1% | | |

It can be seen from Table 2 that the strength values of the removal agents are all improved after the introduction of aluminum oxide/silicon dioxide, the introduction of Al₂O₃ results in a greater increase in strength, but leads to a certain decrease in activity. The introduction of SiO₂ has a better effect, which not only improves the strength, but also improves the activity.

By comparing Example 9 with Example 7, it can be seen that K₂O is further introduced on the basis of the introduction of Al₂O₃, which not only maintains good strength, but also increases the penetration time of CO from 78 minutes to 82 minutes. It can be seen that the introduction of K is beneficial to further enhance the removal ability of the removal agent to CO.

TABLE 3
Evaluation of CO Removal Effect of Example 1 under
Different CO Concentrations at 25° C. and 1 bar

| CO Content in H₂ Feed Gas | Dew Point | CO Penetration Time |
|---|---|---|
| (vol %) | (° C.) | (min) |
| 0.5% | −67 | 83 |
| 0.05% | −66 | 795 |
| 0.01% | −62 | 3720 |

Table 3 shows evaluation results of Example 1 under different CO concentrations at 25° C. and 1 bar. It can be seen that with the decrease of CO concentration, the dew point of product gas slightly increases and the penetration time is prolonged. It shows that the removal agent provided by the present disclosure can remove CO with different concentration levels in hydrogen at the room temperature with almost no hydrogen consumption.

Those skilled in the art can understand that some modifications or adjustments can be made to the present disclosure in light of the instruction of this description. These modifications or adjustments shall also be within the scope defined by the claims of the present disclosure.

1. A removal agent for fine-removal of CO in hydrogen, wherein an active component of the removal agent comprises a composite metal oxide, metal elements in the composite metal oxide are Cu, Ce, Mn and Bi, a general formula of the composite metal oxide is CuₓCe_{3-x-y-z}Mn_{y}Bi_{z}O_{4+δ}, wherein a subscript value of each metal element is a number of atoms of the corresponding metal element in the composite metal oxide, “4+δ” is a number of oxygen atoms required to meet an oxidation state of other elements, 0.2<x<2, 0.05<y<2.8, 0.05<z<1, and x+y+z<3.

2. The removal agent for fine-removal of CO in hydrogen according to claim 1, wherein the active component of the removal agent further optionally comprises other active constituent(s), said other active constituent(s) are selected from one or more of an oxide of Ca, an oxide of K and an oxide of La.

3. The removal agent for fine-removal of CO in hydrogen according to claim 2, wherein a content of said other active constituent(s) is 0.2-20 wt % based on a weight of the composite metal oxide.

4. The removal agent for fine-removal of CO in hydrogen according to of claims 1-3, wherein the removal agent further comprises other component(s), said other component(s) comprise an oxide of silicon and/or an oxide of aluminum.

5. The removal agent for fine-removal of CO in hydrogen according to claim 4, wherein a percentage by weight of said other component(s) based on the removal agent is 2-30%.

6. The removal agent for fine-removal of CO in hydrogen according to of claims 1, wherein in the general formula of the composite metal oxide, 1<x<2;
and/or, 0.05<z<0.5;
and/or, 0.5<y≤2, preferably, 0.5<y≤1.5;
and/or, 2.1≤x+y+z≤2.97;
and/or, 0.5<y≤2, and 2.1≤x+y+z≤2.97.

7. A preparation method for the removal agent according to claims 1, comprising the following steps of:
1) mixing soluble salts of metal elements corresponding to oxides in an active component and preparing an aqueous solution, adding an alkaline substance into the aqueous solution, adjusting a pH to 6-9 to generate coprecipitation, aging, filtering out and washing the coprecipitate to obtain a filter cake;
2) optionally, uniformly mixing the filter cake with optional other component(s) and moulding the mixture; said other component(s) comprising carriers and/or binders, said carriers and/or binders containing a silicon element and/or an aluminum element; preferably, said other component(s) being selected from one or more of silica sol, potassium silicate, alumina sol and pseudo-boehmite; and
3) calcinating to obtain the removal agent.

8. The preparation method according to claim 7, wherein conditions for the calcination comprise a calcination temperature of 200-600° C., and a calcination time of 2-12 hours.

9. A method for removing CO in hydrogen, wherein the CO in hydrogen is removed by using the removal agent according to claim 1.

10. The method for removing CO in hydrogen according to claim 9, wherein the CO in hydrogen is removed at a temperature of 100° C. or below, preferably at a room temperature; and
the removing is carried out in the presence or absence of oxygen.
